(19) United States
(12) Patent Application Publication
(10) Pub. No.: US 2018/0323521 A1
(43) Pub. Date: Nov. 8, 2018

(54) CONNECTOR

(71) Applicant: Sumitomo Wiring Systems, Ltd., Yokkaichi, Mie (JP)

(72) Inventor: Koichi Yokotani, Yokkaichi, Mie (JP)

(21) Appl. No.: 15/772,299

(22) PCT Filed: Oct. 13, 2016
(86) PCT No.: PCT/JP2016/080297

§ 371 Date: Apr. 30, 2018

(30) Foreign Application Priority Data
Nov. 2, 2015 (JP) 2015-215680

(51) Int. Cl. H01R 9/18; H01R 4/34; H01R 4/38; H01R 13/405

(52) U.S. Cl. CPC H01R 9/18; H01R 13/405; H01R 4/38; H01R 4/34

(57) ABSTRACT

A connector (10) includes a conductive member (20) having a bolt fastening portion (23). The bolt fastening portion has a nut receiving surface (26) on a side opposite to a fastening surface (25). A housing (30) has a bottom wall (35) facing the nut receiving surface (26) and two side walls (34) rising from both side edges of the bottom wall (35) in a plate thickness direction of the bolt fastening portion (23). A forwardly-open accommodation space (32) is enclosed by the nut receiving surface (26), the side walls (34) and the bottom wall (35). A nut (40) is accommodated in the accommodation space (32). A lateral rib (38) on the side wall (34) is held laterally in contact with the nut (40). A front rib (39) is in front of the lateral rib (38) on the side wall (34) and can contact the nut (40) from the front.

### BACKGROUND

### Field of the Invention

This specification relates to a connector.

### Description of the Related Art

Japanese Unexamined Patent Publication No. 2015-95358 discloses a device connector to be installed in a vehicle, such as an electric or hybrid vehicle. This device connector includes conductive members, and a device-side housing made of synthetic resin holds the conductive members. The device-side housing includes a primary molded portion and a secondary molded portion integrally molded to this primary molded portion. The primary molded portion is provided with a nut holding portion for holding a nut. The nut holding portion is open forward, and a rib extends in a front-rear direction on a side wall of the nut holding portion. The nut is press-fit into the nut holding portion from the front while the side surface of the nut deforms the rib. The nut is held in the nut holding portion utilizing a property of the rib to return to an original shape due to inherent resilience of the synthetic resin. However, the rib is not provided on an entrance side of the nut holding portion, but on a back side of the nut holding portion. In other words, the rib is provided in a range from the back side of the nut holding portion to a position where the nut is to be finally held. Thus, with the nut held in the nut holding portion, the rib is not present before the side surface of the nut, and the nut may be detached forwardly of the nut holding portion if a holding force by the rib decreases.

### SUMMARY

A connector disclosed by this specification includes a conductive member having a plate-like bolt fastening portion. The bolt fastening portion has a nut receiving surface on a side opposite to a fastening surface. The connector also has a housing with a bottom wall facing the nut receiving surface and two side walls rising from both side edges of the bottom wall in a plate thickness direction of the bolt fastening portion. An accommodation space is enclosed by the nut receiving surface. The side walls and the bottom wall are open forward in the housing. A nut is accommodated in the accommodation space. A lateral rib is provided on the side wall is held laterally in contact with the nut. A front rib is provided in front of the lateral rib on the side wall and is capable of contacting the nut from the front.

According to this configuration, forward detachment of the nut can be avoided by the front rib while the nut is held in the accommodation space by the lateral rib. The front rib may be deformed temporarily by the nut when the nut passes the front rib, but the front rib tries to restore its original shape after the passage of the nut. Even if the front rib does not completely restore its original shape, it is not a problem because the front rib only has to be restored sufficiently for the nut to be retained.

The front rib may be provided on each of the side walls, and the lateral rib may be provided on each of the side walls. Thus, the nut can be sandwiched and held from both sides by the lateral ribs. Further, the nut can be retained firmly by the front ribs.

The front rib and the lateral rib may be configured as a continuous rib. Thus, the front rib and the lateral rib need not be provided separately and the shape of the rib can be simplified.

According to the connector disclosed by this specification, it is possible to avoid forward detachment of the nut from the accommodation space.

### BRIEF DESCRIPTION OF DRAWINGS

FIG. 1 is a front view of a connector in an embodiment.

FIG. 2 is a section along A-A in FIG. 1.

FIG. 3 is a plan view of the connector.

FIG. 4 is a section along B-B in FIG. 3.

FIG. 5 is a section showing a state where a nut is accommodated in an accommodation space when viewed from above.

FIG. 6 is a view enlargedly showing an essential part of FIG. 5.

### DETAILED DESCRIPTION

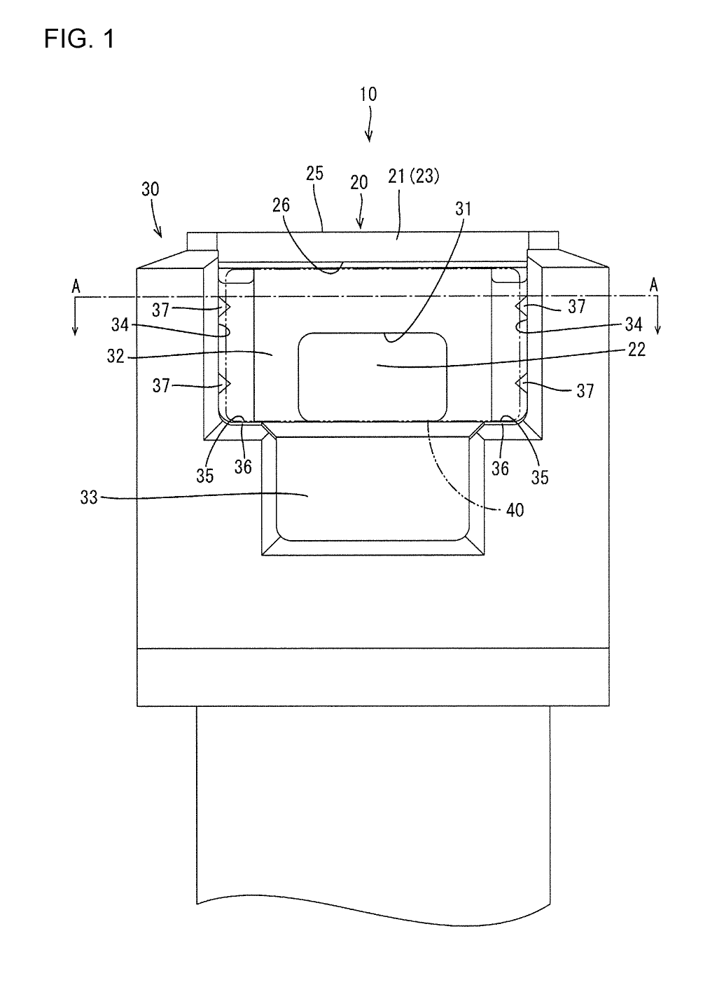

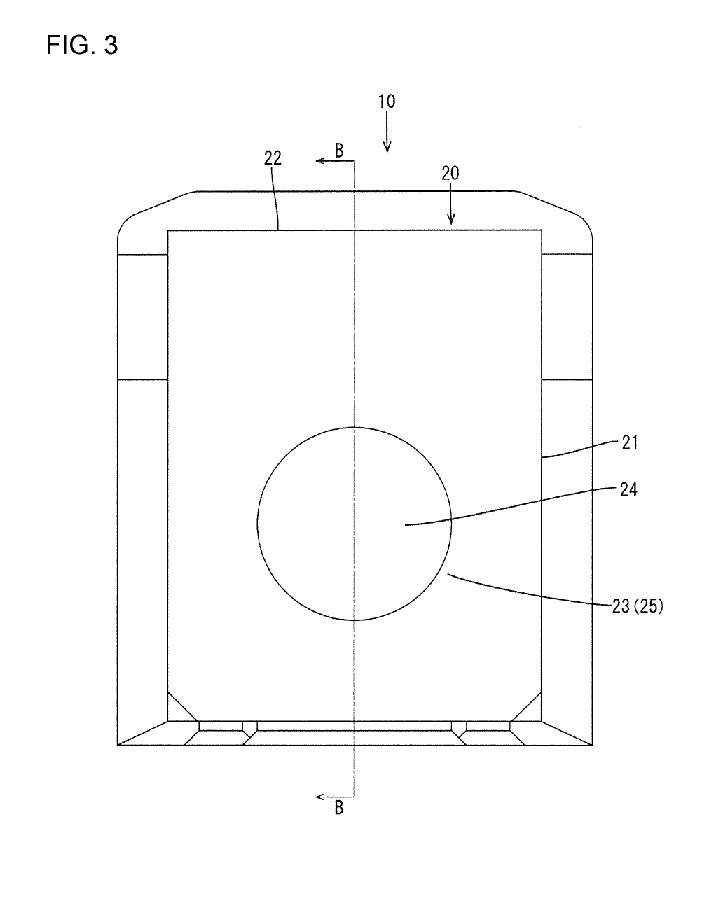

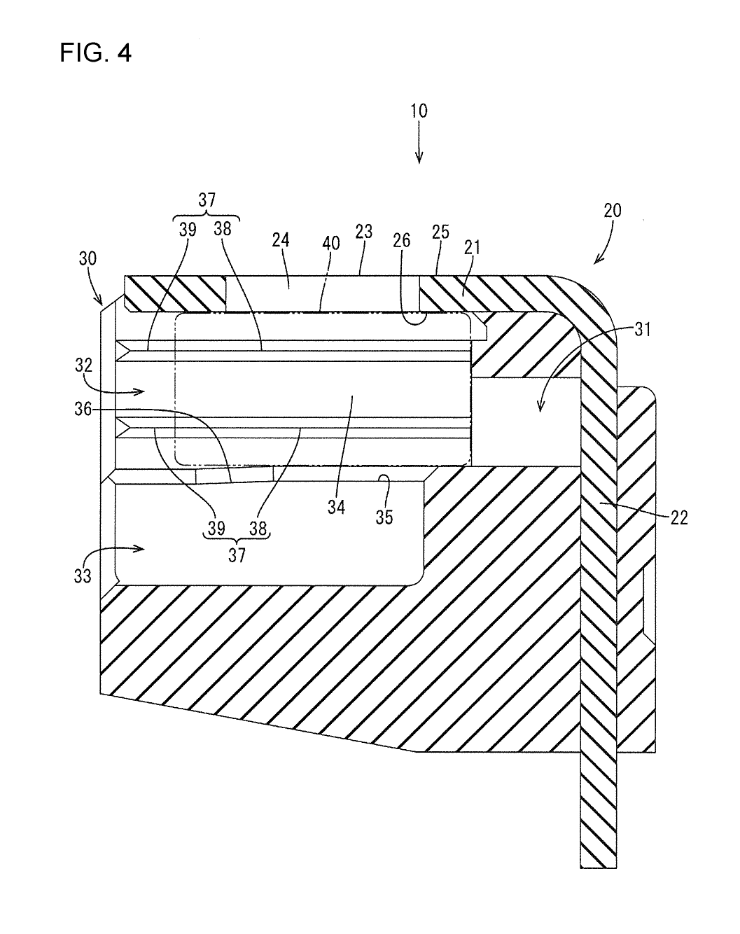

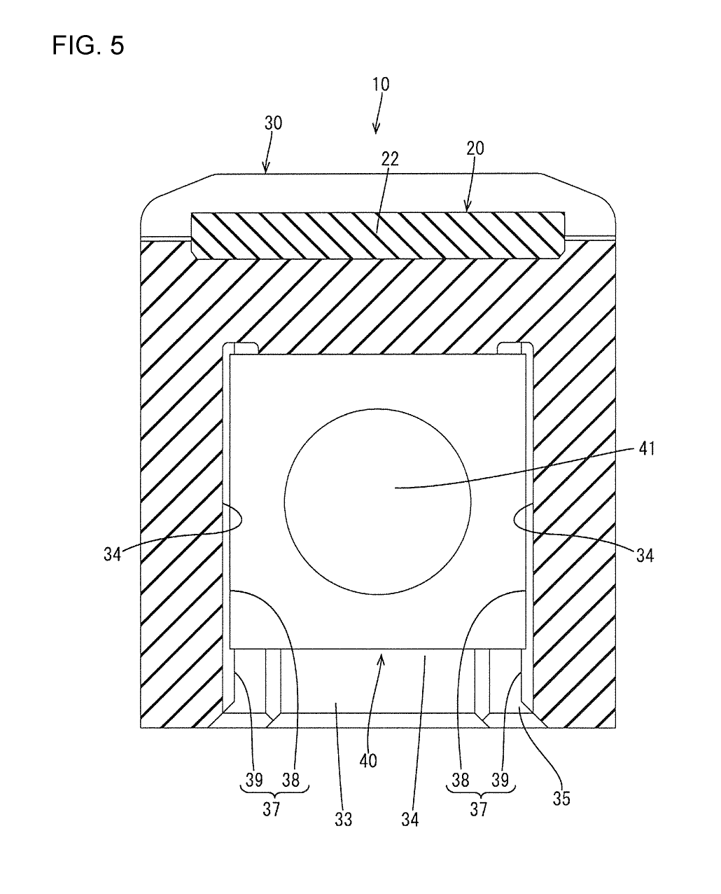

An embodiment is described with reference to FIGS. 1 to 6. A connector 10 in this embodiment is a connection device used to connect a conductive member, such as a busbar, by bolting. The connector 10 includes a conductive member 20 and a housing 30, as shown in FIG. 1, and a nut 40 is held in the housing 30, as shown in FIGS. 4 and 5. The nut 40 is a square nut having a substantially square shape in a plan view and includes a screw hole 41 in a center. In the following description, a side forward of the plane of FIG. 1 is referred to as a front concerning a front-rear direction and a vertical direction is based on FIG. 1.

The conductive member 20 is obtained by press-working a conductive metal plate and includes, as shown in FIG. 4, a plate-like horizontal portion 21 extending in a horizontal direction. A vertical portion 22 extends perpendicularly from the rear end of the horizontal portion 21 and is provided with a bolt fastening portion 23. The bolt fastening portion 23 includes a bolt hole 24 through which an unillustrated bolt is inserted, and a fastening surface 25 is formed around the bolt hole 24. A nut receiving surface 26 for receiving the upper surface of the nut 40 is provided on a side of the bolt fastening portion 23 opposite to the fastening surface 25.

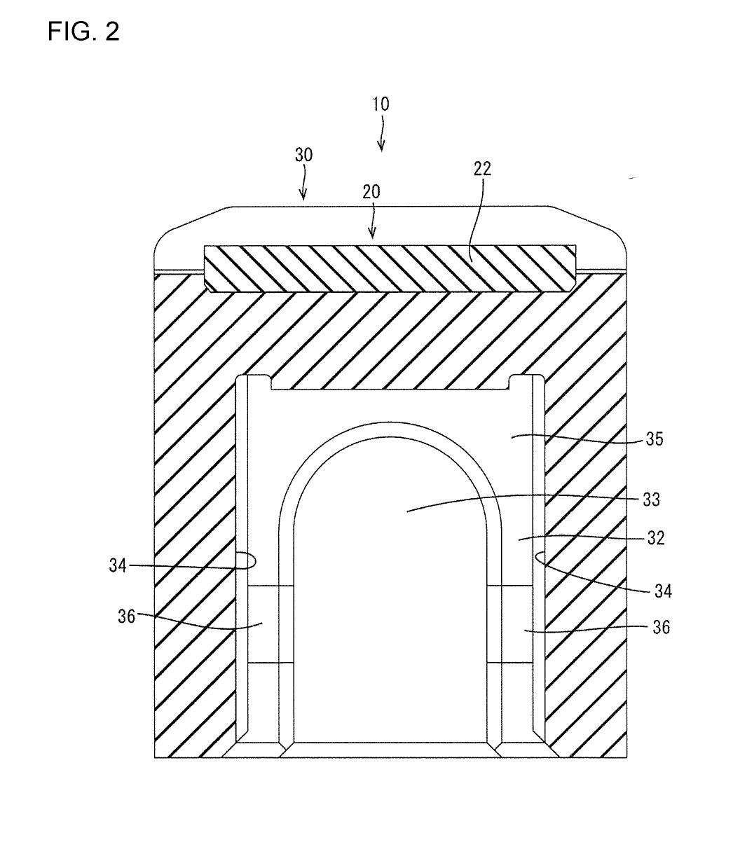

Most of the vertical portion 22 is embedded in the housing 30 and a part of the vertical portion 22 is exposed to the outside of the housing 30. The housing 30 includes an accommodation space 32 for accommodating the nut 40, a rear opening 31 formed behind the accommodation space 32 and an escaping space 33 for allowing a shaft of an unillustrated bolt to escape. The rear opening 31, the accommodation space 32 and the escaping space 33 open forward. Thus, a part of the vertical portion 22 is facing forward via the accommodation space 32 and the escaping space 33. As shown in FIG. 2, the rear end surface of the escaping space 33 has an arcuate shape in conformity with an outer peripheral side of the shaft of the bolt.

As shown in FIG. 1, the accommodation space 32 is enclosed by the nut receiving surface 26 of the bolt fastening portion 23, two side walls 34 extending in a plate thickness direction of the bolt fastening portion 23 and a bottom wall 35 facing the nut receiving surface 26. The side walls 34 rise from both sides of the bottom wall 35 in the plate thickness direction of the bolt fastening portion 23. Further, the side walls 34 face each other in a direction perpendicular to the plate thickness direction of the bolt fastening portion 23.

As shown in FIG. 4, a tapered portion 36 is provided at an intermediate position of the bottom wall 35 and is inclined gently up toward the rear. This makes a vertical dimension of a front end of the accommodation space 32 larger than that of the nut 40 so that the nut 40 is inserted easily into the accommodation space 32. On the other hand, a vertical dimension of a rear end of the accommodation space 32 is substantially equal to that of the nut 40 so that the nut 40 can be accommodated in a proper accommodation posture in the accommodation space 32.

As shown in FIG. 4, the side wall 34 of the accommodation space 32 is provided with upper and lower ribs 37. The ribs 37 are provided on each of the two side walls 34 and continuously extend straight from the rear surface of the accommodation space 32 to an opening edge part on a front end. As shown in FIG. 1, the ribs 37 have a triangular shape when viewed from front. As shown in FIG. 5, each rib 37 is composed of a lateral rib 38 disposed laterally of the nut 40 and a front rib 39 disposed in front of the nut 40. The lateral ribs 38 have tips squeezed as the nut 40 is press-fit and the nut 40 is pressed from both sides by resilience produced when the resin is restored. In this way, the nut 40 is held in the accommodation space 32.

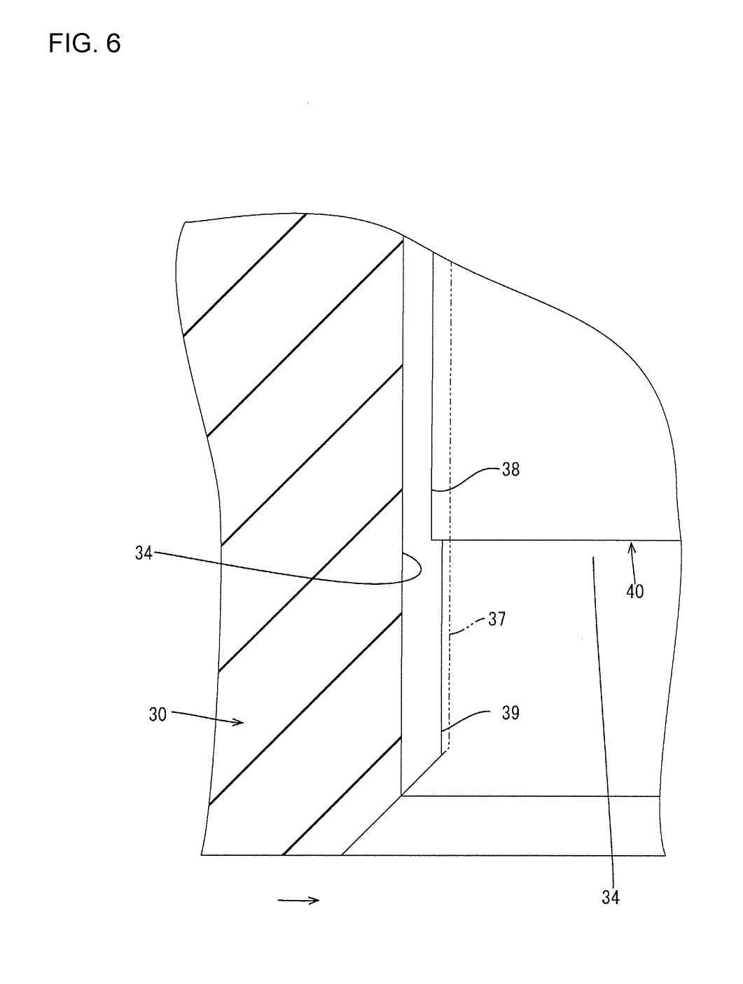

The rib 37 shown by chain double-dashed line in FIG. 6 shows a state before the nut 40 is accommodated into the accommodation space 32. When the nut 40 is press-fit into the accommodation space 32 from the front, the tip of the rib 37 is squeezed by the side surface of the nut 40, and the lateral rib 38 is deformed. On the other hand, a part of the rib 37 passed by the nut 40 tries to restore its original shape. Thus, the front rib 39 is deformed although this part is not restored to the position of the rib 37 before press-fitting. The tip of the front rib 39 is located between the tip of the lateral rib 38 and that of the rib 37 before press-fitting. By doing so, even if the nut 40 moves forward, the front rib 39 contacts a front end corner part of the nut 40 from the front to impede a forward movement of the nut 40 is impeded.

The connector 10 of this embodiment is molded secondarily with the nut 40 accommodated in the accommodation space 32. At that time, if the side wall 34 is tilted in an arrow direction of FIG. 6 by receiving an injection pressure of resin, the lateral rib 38 is pressed strongly against the side surface of the nut 40. Thus, the tip of the lateral rib 38 is squeezed farther, and a clearance may be formed between the tip of the lateral rib 38 and the side surface of the nut 40. Therefore, a holding force for holding the nut 40 by the lateral rib 38 after secondary molding may be reduced and the nut 40 may be detached from the housing 40.

In that respect, the detachment of the nut 40 can be prevented by the front ribs 39 disposed forwardly of the lateral ribs 38 in this embodiment. Further, even if the side wall 34 is tilted in the arrow direction of FIG. 6, a distance between the tips of the front ribs 39 arranged to face each other becomes shorter (the front end opening of the accommodation space 32 becomes narrower) without squeezing the tip of the front rib 39 by the side surface of the nut 40 so that detachment of the nut 40 is prevented more easily.

As described above, forward detachment of the nut 40 can be avoided by the front ribs 39 while the nut 40 is held in the accommodation space by the lateral ribs 38. Note that even if the front ribs 39 are deformed temporarily by the nut 40 when the nut 40 passes the front ribs 39, the front ribs 39 try to restore their original shapes after the passage of the nut 40. Even if the front ribs 39 do not restore completely to their original shapes, it is not a problem because only the front ribs 39 have to restore to retain the nut 40.

The front rib 39 may be provided on each of the two side walls 34, and the lateral rib 38 may be provided on each of the two side walls 34. Thus, the nut 40 can be sandwiched and held from both sides by the lateral ribs 38. Further, the nut 40 can be retained firmly by the two front ribs 39.

The front rib 39 and the lateral rib 38 may be configured as the continuous rib 37. Thus, the front rib 39 and the lateral rib 38 need not be provided separately, and the shape of the rib 37 can be simplified.

The invention is not limited to the above described and illustrated embodiment. For example, the following modes also are included.

Although the rib 37 is provided on each of the two side walls 34 in the above embodiment, the rib 37 may be provided only on one side wall 34.

Although the front rib 39 and the lateral rib 38 are configured as the continuous rib 37 in the above embodiment, a front rib and a lateral rib may be provided separately.

Although the nut 40 having a square shape is illustrated in the above embodiment, a nut having a hexagonal shape may be used.

### LIST OF REFERENCE SIGNS

10 . . . connector
20 . . . conductive member
23 . . . bolt fastening portion
25 . . . fastening surface
26 . . . nut receiving surface
30 . . . housing
32 . . . accommodation space
34 . . . side wall
35 . . . bottom wall
37 . . . rib
38 . . . lateral rib
39 . . . front rib
40 . . . nut

1. A connector, comprising:
a conductive member including a plate-shaped bolt fastening portion, the bolt fastening portion having a nut receiving surface on a side opposite to a fastening surface;
a housing including a bottom wall facing the nut receiving surface an first and second side walls rising from first and second side edges of the bottom wall in a plate thickness direction of the bolt fastening portion, an accommodation space enclosed by the nut receiving surface, the side walls and the bottom wall being provided to be open forward in the housing;
a nut accommodated in the accommodation space;
a lateral rib provided on the side wall, the lateral rib being laterally held in contact with the nut by having a tip of the rib before press-fitting squeezed by a side surface of the nut; and
a front rib provided in front of the lateral rib on the side wall, the front rib being configured for contacting the nut from the front;
the tip of the front rib being located between that of the lateral rib after press-fitting and that of the rib before press-fitting, the front rib having a step coupling the tip of the lateral rib after press-fitting and that of the front rib, the step being held in contact with the nut from front.

2. The connector of claim 1, wherein the front rib comprises first and second front ribs provided respectively on the first and second side walls, and the lateral rib is comprises first and second lateral ribs provided respectively on the first and second side walls.

3. The connector of claim 2, wherein the front rib and the lateral rib are configured as a continuous rib.

4. The connector of claim 1, wherein the front rib and the lateral rib are configured as a continuous rib.
